(19) United States
(12) Patent Application Publication
(10) Pub. No.: US 2025/0096499 A1
(43) Pub. Date: Mar. 20, 2025

(54) HIGH-DENSITY ELASTIC-CONTACT HIGH-SPEED CONNECTOR ASSEMBLY

(71) Applicant: RESEARCH ON ELECTRICAL APPLIANCES OF SHANGHAI ASTRONAUTICS, Shanghai (CN)

(72) Inventor: Haixu ZHANG, Shanghai (CN)

(21) Appl. No.: 18/913,653

(22) Filed: Oct. 11, 2024

Related U.S. Application Data
(63) Continuation-in-part of application No. PCT/CN2023/099306, filed on Jun. 9, 2023.

(30) Foreign Application Priority Data
Jun. 21, 2022 (CN) 202210704944.1

(51) Int. Cl. H01R 13/405; H01R 12/71; H01R 13/24

(52) U.S. Cl. CPC H01R 13/405; H01R 12/714; H01R 13/2442

(57) ABSTRACT

A high-density elastic-contact high-speed connector assembly is provided, wherein a contact member is arranged inside the upper base and the lower base, and a head part of the contact member is located in the upper base for butting with a butting end to realize a transmission of a signal, and a tail part of the contact member extends to an outside of the lower base for cooperating with a PAD on a PCB board to realize an elastic contact between the connector and the PCB board, so as to realize the transmission of the signal.

### CROSS-REFERENCE TO RELATED APPLICATION

The present disclosure is a U.S. national phase application of PCT International Application No. PCT/CN2023/099306 filed on Jun. 9, 2023, and claims priority to Chinese patent Application No. 202210704944.1, filed with the Chinese Patent Office on Jun. 21, 2022, entitled “HIGH-DENSITY ELASTIC-CONTACT HIGH-SPEED CONNECTOR ASSEMBLY”, the entire contents of which are incorporated herein by reference.

### TECHNICAL FIELD

The present disclosure relates to the technical field of connecting electrical components, and in particular to a high-density elastic-contact high-speed connector assembly.

### BACKGROUND ART

For most of the high-speed connectors, the density of the contact member is very high, and at the same time, the contact reliability of the contact member is required to be very high. The connectors and PCB boards (printed circuit boards) in prior art are mostly connected in the form of welding, and pressing, etc. Such structure is very inconvenient to assemble because the connector required to be welded needs to be provided with the specialized welding device, and the connector required to be pressed needs to be provided with a large device carrying out pressing operations, which brings great inconvenience for processing and production for the existing PCB board components in high density condition.

### SUMMARY

The present disclosure provides a high-density elastic-contact high-speed connector assembly.

The embodiments of the present disclosure provide a high-density elastic-contact high-speed connector assembly, wherein the high-density elastic-contact high-speed connector assembly can include an upper base and a lower base, and a contact member is arranged inside the upper base and the lower base, wherein a head part of the contact member is located in the upper base for butting with a butting end to realize a transmission of a signal, and a tail part of the contact member extends to an outside of the lower base for cooperating with a PAD (pad) on a PCB board to realize an elastic contact between the connector and the PCB board, so as to realize the transmission of the signal, wherein
the high-density elastic-contact high-speed connector assembly further includes a pin, and the pin is riveted after passing through a through hole arranged in the upper base and the lower base and cooperating with an opening of the PCB board, so that the connector is fixed to the PCB board.

### BRIEF DESCRIPTION OF DRAWINGS

FIG. 1 is a structure schematic diagram of a high-density elastic-contact high-speed connector assembly provided by some embodiments of the present disclosure;

FIG. 2 shows a partially enlarged diagram of the cooperation between a contact member and an upper base and a lower base in some embodiments of the present disclosure;

FIG. 3 shows a schematic diagram of a contact member structure provided by some embodiments of the present disclosure;

FIG. 4 shows a contact schematic diagram of a connector contact member and a PAD of a PCB board provided by some embodiments of the present disclosure; and

FIG. 5 shows a PAD distribution schematic diagram of a PCB board provided by some embodiments of the present disclosure.

Reference numbers: upper base 1, lower base 2, boss part 21, through-hole structure 22, pin 3, contact member 4, front end 41, assembly guiding structure 42, barbed structure 43, position limitation structure 44, cantilever structure 45, and are structure 46.

### DETAILED DESCRIPTION OF EMBODIMENTS

In order to make the purpose, technical solutions, and advantages of the embodiments of the present disclosure clearer, the technical solutions in the embodiments of the present disclosure will be described clearly and completely as follows in conjunction with drawings in the embodiments of the present disclosure. It is clear that the embodiments described are only partial embodiments of the present disclosure, and not all of the embodiments. Based on the embodiments in the present disclosure, all other embodiments obtained by a person of ordinary skill in the art without inventive efforts shall fall within the scope of protection of the present disclosure.

In some optional embodiments, a square groove structure for mounting the contact member can be arranged at an interior of the lower base.

In some optional embodiments, the head part of the contact member can be provided as a front end, and the tail part of the contact member can be provided as an arc structure.

In some optional embodiments, a boss part can be arranged at an interior of the square groove structure; and the contact member can be provided with an assembly guiding structure, and a position limitation structure and a cantilever structure cooperating with the boss part.

In some optional embodiments, the contact member can be provided with a barbed structure; and the square groove structure can be provided with a through-hole structure, wherein the barbed structure and the through-hole structure can cooperate with each other.

In some optional embodiments, the number and position of the contact member can correspond to those of the PAD on the PCB board.

In some optional embodiments, the cantilever structure can be elastically deformed.

In some optional embodiments, the barbed structure and the through-hole structure can be provided to prevent the contact member from moving up and down within the upper base and the lower base.

The present disclosure includes at least the following beneficial effects.

The high-density elastic-contact high-speed connector assembly provided by the embodiments of the present disclosure realizes a function of reliable contact by using a method of elastic contact in the design of the product of the contact member. The finished connector is assembled through fixing the upper base and the lower base by the contact member, and the connector is fixed to the PCB board by pins. This contact method of the contact member ensures the reliable signal transmission between the PCB board and the connector and the reliable contact between the contact member and the butting end, so as to realize the reliable signal transmission between the PCB boards and between the PCB boards and the device.

The high-density elastic-contact high-speed connector assembly provided by the embodiments of the present disclosure is particularly suitable for the PCB board applied to the high-density components and other application situations requiring the high contact performance.

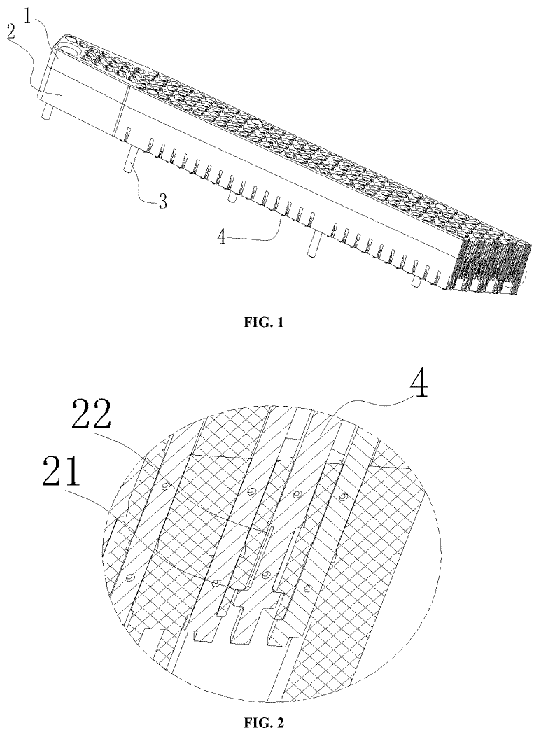

As shown in FIG. 1, some embodiments of the present disclosure provide a high-density elastic-contact high-speed connector assembly. The high-density elastic-contact high-speed connector assembly includes an upper base 1 and a lower base 2, and a contact member 4 is arranged inside the upper base 1 and the lower base 2, wherein the number and the position of the contact members 4 can correspond to those of the PAD on the PCB board with which the contact member 4 is to be connected (for example, the distribution of the PAD on the PCB board is shown in FIG. 5). The head part of the contact member 4 can be located in the upper base 1 for butting with a butting end to realize the transmission of the signal; and a tail part of the contact member 4 extends to an outside of the lower base 2 for cooperating with the PAD on the PCB board to realize an elastic contact between the connector and the PCB board, so as to realize the transmission of the signal.

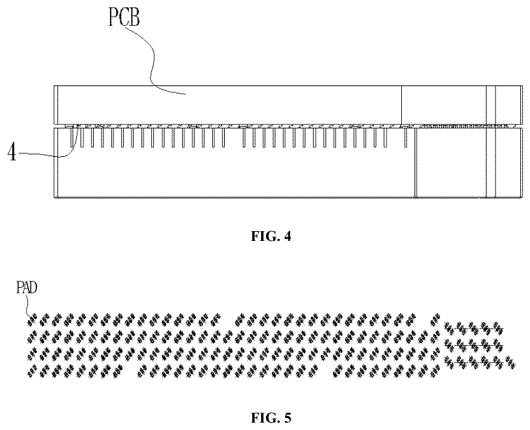

The high-density elastic-contact high-speed connector assembly can further include a pin 3, and the pin 3 is riveted after passing through a through hole arranged in the upper base 1 and the lower base 2 and cooperating with an opening of the PCB board, so that the connector is fixed to the PCB board, as shown in FIG. 4.

In the high-density elastic-contact high-speed connector assembly provided by some embodiments of the present disclosure, the upper base 1 and the lower base 2 cooperate with each other to limit the contact member 4 from moving upward and downward, and left and right, and the connector is fixedly connected to the PCB board by utilizing the pin 3. After the connector is fixedly connected to the PCB board, the head part of the contact member 4 is used to butt with the butting end, and the tail part of the contact member 4 is used to cooperate with the PAD on the PCB board, so to realize the elastic contact between the connector and the PCB board, thereby realizing the signal transmission function.

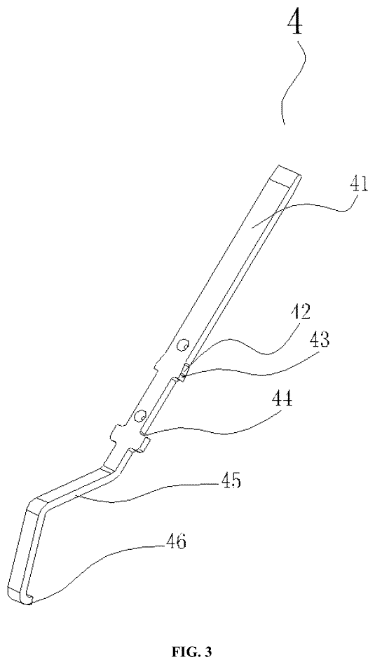

As shown in FIG. 1, FIG. 2, and FIG. 3, a square groove structure for mounting the contact member 4 is arranged at an interior of the lower base 2, and a boss part 21 can be arranged at an interior of the square groove structure.

The head part of the contact member 4 can be provided as a front end 41 for butting with the butting end, so that the transmission of the signal is realized. The tail part of the contact member 4 can be provided as an arc structure (a curved structure) 46 for cooperating with the PAD on the PCB board, so as to realize the elastic contact between the connector and the PCB board, and to realize the transmission of the signal. The contact member 4 can also be provided with an assembly guiding structure 42 used for guiding during assembly; a position limitation structure 44 cooperating with the boss part 21 to ensure the fixation performance of the contact member 4 within the upper base 1 and the lower base 2; and a cantilever structure 45, wherein the cantilever structure 45 is used to elastically deform to contact with the PAD on the PCB board, so as to realize the signal transmission between the connector and the PCB board.

Additionally, the contact member 4 can further be provided with a barbed structure 43. Accordingly, the square groove structure can be provided with a through-hole structure 22. The barbed structure 43 on the contact member 4 cooperates with the through-hole structure 22 on the square groove structure, so as to prevent the contact member 4 from moving upward and downward in the upper base 1 and the lower base 2, thereby ensuring that the contact member 4 is perfectly fixed when the connector is butted.

In the high-density elastic-contact high-speed connector assembly provided by the embodiments of the present disclosure, the function of reliable contact can be realized by using a method of elastic contact in the design of the product of the contact member 4. Specifically, the finished connector is assembled through fixing the upper base 1 and the lower base 2 by the contact member 4, and the connector is fixed by the pin 3 and the PCB board. This contact method of the contact member 4 ensures the reliable signal transmission between the PCB board and the connector and the reliable contact between the contact member 4 and the butting end, so as to realize the reliable signal transmission between the PCB boards and between the PCB boards and the device.

It should be noted that when a component is referred to be “fixed” to the other component, it can be directly arranged on the other component, or a centered component can exist. When a component is considered to be “connected” to another component, it can be directly connected to the other component, or a centered component can exist at the same time.

It is to be noted that in the text, relationship terms such as first and second, etc., are used merely to distinguish one entity or operation from another, and do not necessarily require or imply the existence of any actual relationship or order between those entities or operations. Furthermore, the terms “include”, “comprise” or any other variations thereof are intended to cover a non-exclusive inclusion, so that a process, method, object, or device including a series of elements includes not only those elements, but also other elements that are not explicitly listed, or the elements that are inherent to this process, method, object, or device. Without further limitation, the element defined by a phrase “including a . . . ” does not exclude that the other same elements also exist in the process, method, object, or device including the element.

The above embodiments are only used to illustrate the technical solutions of the present disclosure, and not to restrict it. Although the present disclosure is described in detail with reference to the foregoing embodiments, it should be understood by persons of ordinary skill in the art that they can still modify the technical solutions described in the foregoing embodiments or make equivalent substitutions for some or all of the technical features; and these modifications or substitutions do not take the essence of the corresponding technical solutions out of the scope and spirit of the technical solutions in each embodiment of the present disclosure.

The invention claimed is:

1. A high-density elastic-contact high-speed connector assembly, wherein the high-density elastic-contact high-speed connector assembly comprises an upper base and a lower base, and a contact member is arranged inside the upper base and the lower base, wherein a head part of the contact member is located in the upper base for butting with a butting end to realize a transmission of a signal, and a tail part of the contact member extends to an outside of the lower base for cooperating with a PAD on a PCB board to realize an elastic contact between the connector and the PCB board, so as to realize the transmission of the signal, wherein
the high-density elastic-contact high-speed connector assembly further comprises a pin, and the pin is riveted after passing through a through hole arranged in the upper base and the lower base and cooperating with an opening of the PCB board, so that the connector is fixed to the PCB board.

2. The high-density elastic-contact high-speed connector assembly according to claim 1, wherein a square groove structure for mounting the contact member is arranged at an interior of the lower base.

3. The high-density elastic-contact high-speed connector assembly according to claim 2, wherein the head part of the contact member is provided as a front end, and the tail part of the contact member is provided as an arc structure.

4. The high-density elastic-contact high-speed connector assembly according to claim 2, wherein a boss part is arranged at an interior of the square groove structure; and
the contact member is provided with an assembly guiding structure, and a position limitation structure and a cantilever structure cooperating with the boss part.

5. The high-density elastic-contact high-speed connector assembly according to claim 2, wherein the contact member is provided with a barbed structure; and
the square groove structure is provided with a through-hole structure, wherein the barbed structure and the through-hole structure cooperate with each other.

6. The high-density elastic-contact high-speed connector assembly according to claim 3, wherein a boss part is arranged at an interior of the square groove structure; and
the contact member is provided with an assembly guiding structure, and a position limitation structure and a cantilever structure cooperating with the boss part.

7. The high-density elastic-contact high-speed connector assembly according to claim 1, wherein the number and position of the contact member correspond to those of the PAD on the PCB board.

8. The high-density elastic-contact high-speed connector assembly according to claim 4, wherein the cantilever structure can be elastically deformed.

9. The high-density elastic-contact high-speed connector assembly according to claim 6, wherein the cantilever structure can be elastically deformed.

10. The high-density elastic-contact high-speed connector assembly according to claim 5, wherein the barbed structure and the through-hole structure are provided to prevent the contact member from moving up and down within the upper base and the lower base.
